(19) United States
(12) Patent Application Publication
(10) Pub. No.: US 2010/0054237 A1
(43) Pub. Date: Mar. 4, 2010

(54) SYNCHRONIZATION FOR FEMTO-CELL BASE STATIONS

(75) Inventors: Guang Han, Arlington Heights, IL (US); Rajeev Agrawal, Northbrook, IL (US); Anand S. Bedekar, Arlington Heights, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/509,508

(22) Filed: Jul. 27, 2009

Related U.S. Application Data
(60) Provisional application No. 61/094,100, filed on Sep. 4, 2008.

(51) Int. Cl. H04J 3/06

(52) U.S. Cl. 370/350

(57) ABSTRACT

Timing synchronization between base stations of uncoordinated communication networks includes obtaining timing synchronization information from one base station, and adjusting a clock of the other station in response to the synchronization information. The timing synchronization information can be identified from a strongest synchronization signal from nearby uncoordinated base stations. The timing synchronization can accommodate clock offsets and frequency offsets.

### FIELD OF THE INVENTION

This invention relates to wireless communication networks, and in particular, to a mechanism for synchronization of femto-cell base stations.

### BACKGROUND OF THE INVENTION

In the current wireless communication business, many different telecommunication operators exist that provide various different wireless communication networks, some of which overlap with each other. In a scenario involving uncoordinated networks (i.e. where there is no central spectrum allocation authority between different networks), such as for example wireless local area networks (LANs) such as IEEE 802.11b, Bluetooth™, Wi-Fi, the digital European cordless telephone (DECT) standard, or other ad-hoc shared-spectrum networks, it is very possible that these different communication networks will interference with each other, particularly when using the same frequency band.

In effect, communication devices on one network have no knowledge of interference that they are causing to communication devices on another network. Such networks typically operate using dynamic channel methods that select a channel for operation depending on the level of interference measured on that channel. For example, where different Time Division Duplex (TDD) systems are operating in a band, on adjacent channels, or on adjacent sites on the same channel, interference between systems can occur when one network is transmitting, and another unrelated network is receiving. This interference is a particular problem between networks that overlap, such as when one communication network overlays (e.g. macro-cells) another communication network (e.g. femto-cells).

This interference could be significantly reduced if the overlapping communication networks were synchronised. However, for smaller unconnected networks there is no central mechanism to force synchronisation, and therefore the networks operated in an uncoordinated manner. This is exacerbated for TDD systems that have no frequency planning, as in unregulated spectrum, e.g. Wi-Fi. As such, these uncoordinated systems do not enable fair access to the available communication resources for each network sharing the resource—that is one network may so degrade the quality of the other to effectively prevent it from operating properly.

One technique to provide synchronization would be to provide synchronizing information over a backhaul system (e.g. DSL or cable) to the underlying network. However, a local backhaul connection (DSL or cable) may introduce unpredictable large delay. In addition, telecom operators have no control over such a backhaul connection. Thus it may not be used to transmit synchronization signal.

Another technique to provide synchronization would be to provide a high precision local reference oscillator (e.g. an ovenized temperature compensated crystal oscillator). However, such a solution is quite expensive, and is not practical for smaller networks, such as in a home environment.

Another technique to provide synchronization would be to provide Global Positioning System (GPS) receivers for each femto-cell base station. Again however, such a solution is quite expensive, and is not practical for smaller networks, such as in a home environment. Moreover, home networks are usually installed indoors, where GPS receivers may not work properly.

Another alternative is to use IEEE 1588, which requires small delay variation and symmetric downlink/uplink delay over the backhaul connection. However, there is no guarantee that the H(e)NB backhaul (DSL/cable) can meet these requirements.

Thus, there exists a need in the field of the present invention to provide stable timing synchronization. In particular, it would be of benefit for TDD and broadcast systems to provide time synchronization between overlaying network cells in order to avoid cross interference between uplink and downlink channels.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 shows an overview block diagram of a wireless communication system supporting multiple technologies/networks, in accordance with the present invention;

FIG. 2 shows a diagram that illustrates the timing errors that can exist in communication networks;

FIG. 3 illustrates an instruction sequence, in accordance with an alternative embodiment of the present invention, and

FIG. 4 is a flow chart illustrating a method, in accordance with the present invention.

Skilled artisans will appreciate that common but well-understood elements that are useful or necessary in a commercially feasible embodiment are typically not depicted or described in order to facilitate a less obstructed view of these various embodiments of the present invention.

### DESCRIPTION OF THE PREFERRED EMBODIMENTS

The present invention provides a framework wherein a BS on one network can provide synchronization to a BS in another network. In particular, the present invention allows a BS to synchronize itself to uncoordinated infrastructure in the locality. The present invention has applicability for cellular base stations, but is also relevant for other communication systems. As described herein, a femto-cell base station, home base station, home Node B, and H(e)NB refer to the same entity.

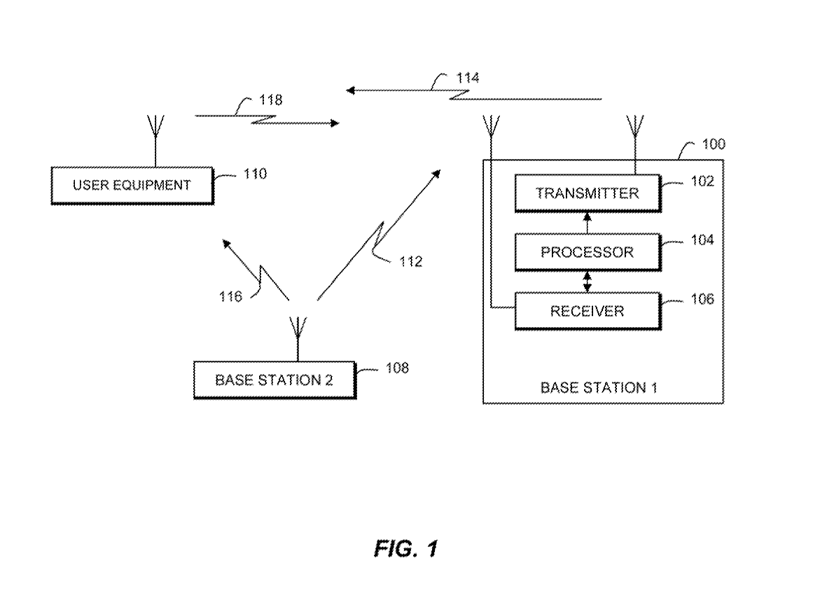

Referring first to FIG. 1, there is shown a block diagram of a base station (BS1 100) adapted to support the inventive concepts of the preferred embodiments of the present invention. Although the present invention is described with reference to a base station, it is within the contemplation of the present invention that the inventive concepts can be applied equally to other wireless communication units, such as mobile stations in cellular-type networks, or devices with wireless Bluetooth™ capabilities, or indeed any other device that has an ability to communicate in other wireless communication networks. BS1 100 can have an antenna that can be coupled to a duplex filter or antenna switch that provides isolation between a receiver and a transmitter chain within the BS, or the BS can provide separate antenna structures for the transmit (Tx) and receive (Rx) functions (as shown). As known in the art, the receiver 106 typically includes receiver front-end circuitry (effectively providing reception, filtering and intermediate or base-band frequency conversion) that is able to receive signals from a user equipment 110 it is serving or other base stations 108. The receiver 106 is coupled to a signal processor function 104. An output from the signal processing function can be coupled to a transmitter 102 that provides transmissions 114 to user equipment 110 being served by the base station 100 in its locality. In particular, in response to the processor 104, a transmit signal is passed through modulation circuitry and a power amplifier of the transmitter 102 to be radiated from the Tx antenna. The transmitter/modulation circuitry 102 and receiver front-end circuitry 106 comprise frequency up-conversion and frequency down-conversion functions, as are known in the art. The processor function 104 can also include a memory for storing information and measurements and a clock or timer to control the timing of operations (transmission or reception of time-dependent signals) within the base station 100.

Of course, the various components within the BS unit 100 can be arranged in any suitable functional topology able to utilise the inventive concepts of the present invention. Furthermore, the various components within the BS unit 100 can be realised in discrete or integrated component form, with an ultimate structure therefore being merely based on general design considerations. It is within the contemplation of the invention that the operating requirements of the present invention can be implemented in software, firmware or hardware, with the function being implemented in a software processor (or indeed a digital signal processor (DSP)) being merely a preferred option. The inventive concepts herein described can be applied to a situation where there are two such networks that may be able to evolve individually, but have no way of adjusting respectively their communication habits with respect to each other. For example, their lack of appreciation of the other network's needs could be due to the use of different technologies, or for security reasons when both networks use the same technology, or perhaps even due to the usage patterns of each network being different.

Referring back to FIG. 1, a first femto-cell base station 100 is provided timing synchronization via a second macro-cell base station. BS1 100 and user equipment 110 are operable on the first communication network, and BS2 108 is operable in a second communication network, uncoordinated with the first communication network, and may overlay the first communication network. The first and second networks can operate within a band, on adjacent channels, or on the same or adjacent sites on the same channel, which is typical in a wireless cell-based communication system, such that interference can occur between the networks. The user equipment 110 can be configured to operate on both communication networks.

In a specific embodiment, the present invention relates to home networking, wherein a home enhanced Node B (H(e)NB), or HNB, that provides femto-cell coverage. The femto-cell is overlain by macro-cell cellular coverage, wherein the home network and cellular network are Time Division Duplex (TDD) systems that are uncoordinated. It has been agreed in radio access network standardization groups that the frequency accuracy of a HNB needs to be at least 250 parts per billion (ppb). Although this is a relaxed requirement compared with macro NBs (50 ppb), installing a high accuracy crystal oscillator (e.g. OCXO) for each HNB is not practical due to the stringent cost requirements for femto-cells. In addition to frequency stability, time synchronization is also required for TDD operation. Even for Frequency Division Duplex (FDD) systems, time synchronization will facilitate interference coordination among neighbouring femto-cells.

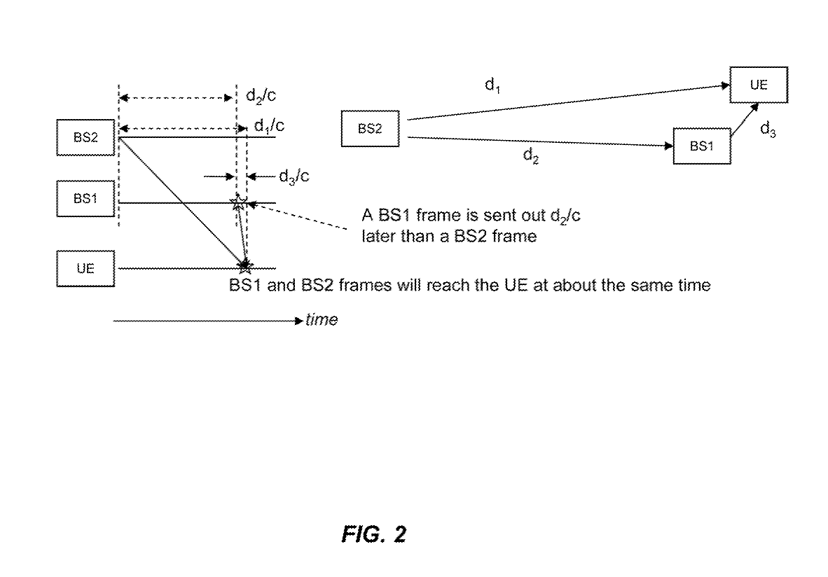

In accordance with the present invention, each femto-cell can incorporate an integrated downlink receiver to synchronize its internal oscillator to a sync burst from a nearby macro-cell base station. Referring to FIG. 2, based on the synchronization burst from the macro-cell base station, the measured clock difference between the femto-cell Node B and the macro-cell base station is equal to the sum of their actual clock difference and a propagation delay, d₂/c. By having the femto-cell adjust its clock by the measured offset, the clock difference is reduced to the propagation delay, which it not easy to estimate accurately. But fortunately, it is not necessary to calibrate the propagation delay out. For example, a femto-cell usually has a limited communication range of thirty meters or less. For a user equipment (UE) within this range, its distance to the macro-cell base station is similar to its distance to the femto-cell plus the distance between the macro-cell base station and the femto-cell base station:

$$\frac{{d}_{2} + {d}_{3} - {d}_{1}}{c} \leq \frac{2 {d}_{3}}{c} = 0.2 μs$$

where c=3×10⁸ meters per second, and d₃=30 meters.

Thus although the femto-cell base station is not exactly time synchronized with the macro-cell base station, their frames will reach the UE at about the same instant. Assume the UE is thirty meters away from the femto-cell base station, the maximum macro/femto-cell timing difference is 0.2 micro-seconds (μs), which is much smaller than a 3 μs TDD mode requirement. This time synchronization accuracy analysis is illustrated in FIG. 2. It should be noted that due to shadowing and multipath, the actual timing error could be larger than 0.2 μs. But it is not likely to exceed the 3 μs timing requirement.

In operation, the receiver 106 of the BS 100 is operable to receive synchronization information from the second communication network. This synchronization information can consist of many different communication system forms, such as a preamble (i.e. for the WiMAX system), a pilot signal, a synchronization burst, frame synchronization information, and the like. This synchronization information is used by the BS 100 to correct a timing difference and/or a frequency offset that exists between the base stations of the two networks. Assuming that the propagation delays are negligible, as explained above, the home base station need only align its timing to match that of the macro-cell base station to provide timing synchronization. Additionally, the home base station can detect a phase difference in the signalling from the macro-cell base station and use this to provide frequency correction.

The synchronization information either can be obtained directly from a base station 108 of the second communication network itself (autonomous mode) or indirectly through measurements of a user equipment 110 that can communication with both networks (user assisted mode). In the autonomous mode, the home BS receiver acts as a listener when a macro-cell BS is broadcasting a synchronization signal. Thus the home BS can acquire synchronization information from nearby macro-cell BS. In the user-assisted mode, the home BS requests a connected user device to measure relevant parameters from the macro-cell BS and report these parameters back to the home BS. The home BS then adjusts its clock based on user-reported parameters.

Specifically, in the autonomous mode, the home BS has the ability to listen to the signal from a macro-cell BS, and execute its synchronization on its own as demonstrated in the following example: a) when turned on, the home BS will identify the strongest synchronization signal (preamble) from nearby macro-cell BSs, b) the home BS periodically listens to this macro BS preamble, and based on the preamble, it corrects its frequency offset and measures the time difference, which is the sum of the clock error and the propagation delay from the macro-cell BS to the home BS. In practice, the home BS does not need to listen to every synchronization signal from the macro-cell BS. The more accurate the clock of the home BS, the less frequently the home BS needs to listen to the macro-cell BS synchronization signal. Although the above actions are appropriate for existing TDD communication systems, for an FDD communication system, the home BS would need an embedded mobile-like receiver in so that the home BS can listen to the synchronization signal from the macro BS.

In the specific user-assisted mode, the home BS utilizes a femto-cell user equipment being served by the home BS to assist in measuring the time and/or frequency offset between the home BS signal and the macro-cell BS signal as demonstrated in the following example: a) the home BS sends a signalling message to the user device that is attached to the femto-cell BS to measure various synchronization-related quantities (propagation delay, etc.) between the user and the macro-cell BS, b) the user device first synchronizes with the macro BS and measures the requested quantities, c) the user device can also compute the frame alignment time offset and frequency offset between the home BS and the macro-cell BS, and d) the user device will report the measurements and/or computed offsets to the home BS in a signalling message. In the above scenario, the propagation delay measured by the femto-cell user equipment may vary due to environmental changes. But it should be noted that the propagation delay itself is small, and such variation should be negligible, as detailed above. Moreover, the home BS could request propagation delay measurements whenever a user device is under its coverage.

A mixed mode approach is also envisioned, where the home BS uses a combination of autonomous mode and user-assisted mode. This mixed mode is based on the home BS's own measurements and the measurements reported by the user device, wherein the home BS can adjust its clock and/or frequency accordingly.

It should be recognized that neighboring femto-cells may synchronize to different macro-cells if they are deployed at the macro-cell edges. If macro cells are not time synchronized with each other (e.g. a FDD system), these neighboring femto-cells can not be time synchronized either. One method to solve this problem is as follows. Once a home BS is synchronized to a macro-cell BS, the home broadcasts the cell ID of the macro-cell BS it is synchronized to and monitors cell IDs that its neighboring home BSs are broadcasting. The home femto-cell BS will periodically compare the values of its associated synchronized macro cell ID and the macro cell IDs broadcasted by its neighboring home BSs. If a neighboring femto-cell home BS broadcasts a different macro-cell ID, the home BS can re-synchronize to this different macro-cell BS so that neighboring femto-cell BSs can synch to the same macro-cell BS. Alternatively, each femto-cell can send a message to a centralized controller (e.g. femto-cell GW) including its cell ID, the cell ID of the macro-cell BS it is synchronized to, the cell IDs of its neighbouring femtocells and the cell IDs of the macro-cell BSs its neighbouring femtocells are synchronized to. Then the centralized controller can respond with the desired macro-cell BS the femtocell should synchronize to. Yet another alternative is to time synchronize all macro-cell BSs in the network, which is up to operator implementation. Note that time synchronization within a cluster of femto-cells can be leveraged to reduce inter-femto-cell interference.

In a preferred embodiment, the home femto-cells and the cellular macro-cells operate in the same frequency band, and the home femto-cells are deployed underlaying the overlaying coverage of the macro-cells. However, it should be noted that the present invention is also operative where the home femto-cells and the cellular macro-cells operate in different frequency bands. In addition, as the femto-cell BS needs to periodically listen to nearby macro BSs, it clearly can not listen and transmit using a downlink frequency at the same time. In this case, the femto-cell BS should disable user equipment downlink reception when it is listening in the downlink receiving mode. For UMTS/HSPA communication system, the home BS makes downlink measurements when the user is in the gap period of the compressed mode. For LTE/WiMAX communication system, a scheduler at the home BS will not schedule any transmission during the time the home BS wants to perform downlink measurements.

The over-the-air synchronization technique described by the present invention enables using cheap oscillators (e.g. those with five ppm frequency error with temperature dependence of 500 ppb per degree) to achieve frequency and time synchronization. However, to ensure 250 ppb frequency accuracy and timing accuracy, a femto-cell base station may need to frequently perform the synchronization operation, especially under severe weather conditions. Moreover, since femto-cell base stations are deployed indoors, poor indoor macro-cell network coverage may incur large femto-cell base station synchronization time. Since a femto-cell base station can not listen and transmit on the same frequency at the same time, the UEs under its service can not detect any transmission from the femto-cell base station whenever it listens to a macro-cell base station. Frequent service interruption without prior notification will clearly impact UE performance. According to these concerns, it is necessary that a femto-cell base station disables its user downlink reception and uplink transmission during the time interval that it is listening to the macro-cell base station. The following mechanism is proposed to enable this functionality for HSPA/LTE systems. However, the techniques described herein can also be used for other communication systems (e.g. WiMAX) as well.

When some UEs of an H(e)NB are in idle mode, the H(e)NB will occasionally page the UEs during their specific paging occasions. To avoid overlapping between these paging occasions and the time interval that the H(e)NB synchronizes to the macro-cell base station, one embodiment provides; a) a locally unique Location Area Code (LAC) for each H(e)NB, where a newly entered UE will initiate a Location Area Update (LAU) procedure with the core network, b) that after the UE receives an LAU accept message from the core network, the UE (or the network) will send a message to the H(e)NB to notify its paging occasion, and c) that in order to ensure the existence of a long enough unused time interval for all idle mode UEs, the paging cycles of these UEs are set relatively large, such as for example having paging cycles at least 64 (or even 128) radio frames for UEs associated with H(e)NBs.

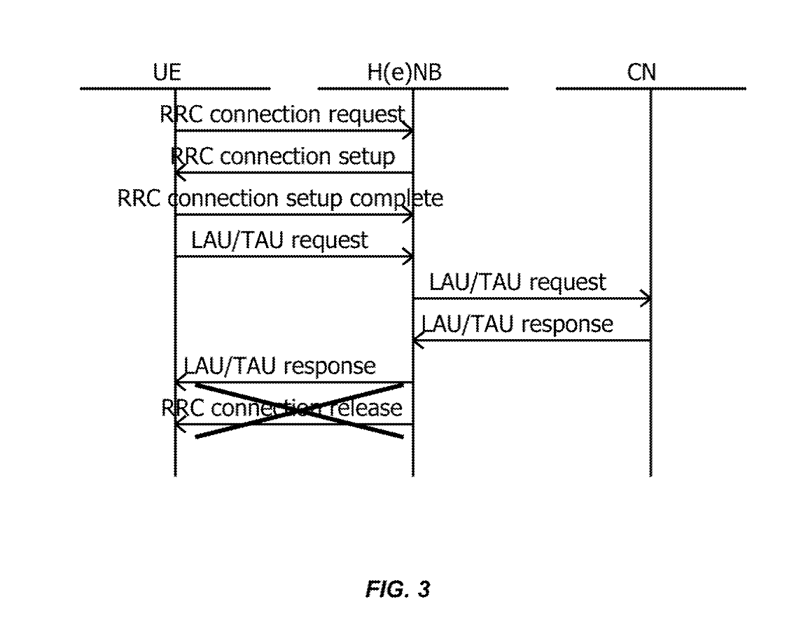

Two alternative solutions are listed as follows: A first alternative is to have all UEs under a femto-cell base station (H(e)NB) being allocated to the same paging group with same paging occasions for all ULEs camping on a femto-cell. Thus it will be much easier for the H(e)NB to identify common unused time intervals. These paging occasions can be reported by some relevant network element (e.g. UEs) to the UEs' home base station. Yet another alternative is to prevent the H(e)NB from sending a RRC Connection Release message (DREG-CMD for IEEE 802.16), as shown in FIG. 3, to any UE in connected mode so that there will be no idle mode UE camping on the H(e)NB. The H(e)NB will need to store the UE context of every UE under its service, and it will have full control of the paging occasions of its UEs. In this case, the home BS can send a message to notify its UEs that it will not be available for a certain amount of time. Note that storing the context of every UE will not require much memory since the number of UEs under a H(e)NB is quite small (e.g. 3-4).

For UEs in active connections, the HeNB (resp. HNB) can send a Radio Resource Control (RRC) Connection Reconfiguration (resp. Radio Bearer Reconfiguration) message to create a measurement gap period for them. This gap period can be contained in the unused period identified in the last step. In addition, an empty cell list can be provided to the UEs in the measurement configuration as part of this RRC Connection Reconfiguration (resp. Radio Bearer Reconfiguration) message. While some gap period is created for the UEs, they should not make any measurements when receiving an empty list. In both of the above cases, the HNB can perform synchronization to the macro-cell base station during the measurement gap period. An alternative is to let H(e)NB simply send a message to all UEs stating that it will go to listening mode for a certain period of time. Being aware of this fact, UEs will not expect any transmission from the H(e)NB and will not make any uplink transmission towards the H(e)NB.

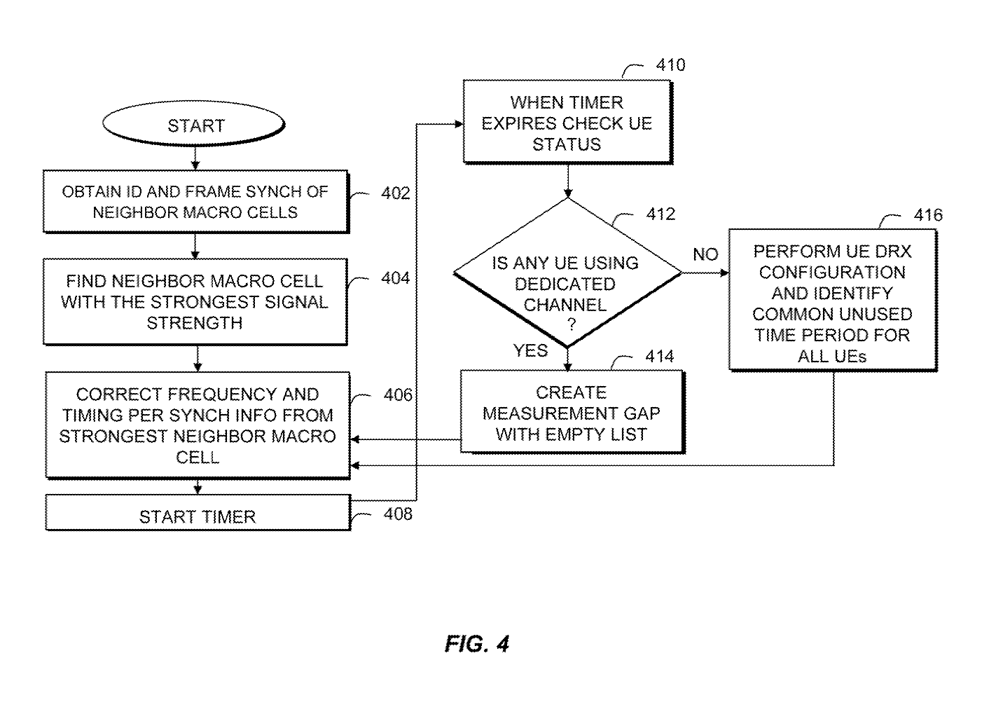

Referring now to FIG. 4, a flowchart illustrates a method for timing synchronization in a first base station of a first communication network via a second base station of second communication network uncoordinated with the first communication network that includes a first step 402 of obtaining the ID and frame timing synchronization of a neighboring or overlaying macro-cell BS. In particular, the home BS performs a cell search to find out physical ID and frame synchronization of neighboring macro-cell BSs. In practice, the home base station listens when the second base station broadcasts a synchronization signal, and disables user device downlink reception and uplink transmission during this time, which can occur normally when the user device is operating in a gap period of a compressed mode. Additionally, this step can include identifying a common user device absence time period while obtaining timing synchronization information from the second base station. Alternatively, the home BS can request a user device attached to the home base station to measure a synchronization parameter of the macro-cell base station, whereupon the user device synchronizes with the macro-cell base station, measures the synchronization parameter, and sends a report with information about the synchronization parameter to the home BS, whereupon the home BS can receive the report from the user device reporting the measured synchronization parameter. The user device can send that actual synchronization parameter to the home BS for it to analyse, or the user device can analyze the synchronization parameter by computing a frame alignment time offset and a frequency offset between the home base station and the macro-cell base station, and reports the computed offsets as synchronization parameters to the home base station.

A next step 404 includes finding those neighboring macro-cells with the strongest signal strength by making measurements of neighboring macro-cells, and picking the macro-cell with the strongest signal strength. This can be accomplished by identifying a strongest synchronization signal preamble from nearby base stations, for example. Steps 402 and 404 should be performed regularly (e.g. in a large cycle such as one day) in case the strongest cell changes, which can be caused by reconfiguration of macro-cell BS transmission power, installation of new macro-cell BSs, etc.).

A next step 406 includes correcting frequency offset and/or timing difference in response to the synchronization information from the strongest-signaled neighboring macro-cell. The timing difference can be accommodated by adjusting a clock of the first base station in response to the synchronization information, and in particular by measuring the time difference as the sum of a clock error and a propagation delay from the macro-cell base station to the home base station. The frequency offset can be accommodated by determining a phase difference of the synchronization information.

A next step 408 includes the home BS starting a timer. The timer is used to ensure that the synchronization is performed every once in a while, and need not be exactly periodic. The smaller the value of the timer, the lower frequency accuracy required on the home BS clock oscillator, which leads to reduced cost. On the other hand, a smaller timer will result in degraded home BS performance.

A next step 410 includes the Home BS checking the status of the UEs it is serving when the timer expires.

A next step 412, determines whether any of the UEs being served by the home BS are using a dedicated channel (DCH).

If not 416, the home BS has the UE perform a discontinuous receive (DRX) mode configuration by sending an RRC_Connection_Reconfiguration message to its users to perform DRX configuration. The home BS identifies common unused time periods for UEs by checking their DRX cycles and paging occasions. And it will perform synchronization during these unused time periods. Users receiving the DRX reconfiguration message may not perform any measurements of surrounding inter-frequency (inter-system) macro-cells if they have good connection quality. They may just stay idle during the gap period. Note that the home BS may not need to perform any DRX reconfiguration if there are plenty of UE unavailable periods such that finding a common long enough unused interval is an easy task. The process then proceeds at step 406.

If so 414, the home BS creates measurement gaps with empty lists for these UEs using DCH. It identifies common unused time periods for its UEs by checking their gap periods, DRX cycles and paging occasions. It performs synchronization during these unused time periods, whereafter the process proceeds at step 406

Optionally, the method can include the steps of broadcasting an identification of the second base station that the first base-station synchronizes to by the first base station; and periodically comparing the value of the identification to second base station identifications broadcasted by neighboring base stations of the first communication network, wherein if a neighboring base station broadcasts a different second base station identification, the first base station will re-synchronize to this second base station with the different second base station identification.

It should be note that it is not necessary to install a full-fledged UE receiver at the home BS. The home BS only needs to listen to synchronization signals from nearby macro-cell BSs. Also, such a downlink receiver can probably be implemented by reusing some components from the existing BS transceiver. However, according to many 3GPP contributions and some femto-cell trials, a downlink receiver will very likely become a necessity for home BSs in order to support plug-and-play operations. For example, in order to find a unique scrambling code, the home BS needs to detect scrambling codes used by neighboring macro-cells, and the home BS needs to measure the transmission power of neighboring macro-cells so as to configure its own transmission power.

Advantageously, by providing timing synchronization of a base station with that of its near neighbors on another uncoordinated communication network, both networks can operate with reduced interference, which can be achieved with very little additional cost, if any. Further, the present invention allows networks in proximity to each other to become coordinated without any central directing mechanism. Although the present invention is described with reference to base stations in a cell-based wireless communication system, it will be appreciated that the inventive concepts hereinbefore described are equally applicable to any wireless communication system where interference exists between any types of communication units.

It will be understood that the terms and expressions used herein have the ordinary meaning as is accorded to such terms and expressions by persons skilled in the field of the invention as set forth above except where specific meanings have otherwise been set forth herein.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for timing synchronization in a first base station of a first communication network via a second base station of second communication network uncoordinated with the first communication network, the method comprising the step of:
obtaining timing synchronization information from the second base station; and
adjusting a clock of the first base station in response to the synchronization information.

2. The method of claim 1, wherein the obtaining step includes the first base station listening when the second base station broadcasts a synchronization signal.

3. The method of claim 2, wherein the obtaining step includes the first base station identifying a strongest synchronization signal preamble from nearby second base stations.

4. The method of claim 1, wherein the adjusting step includes correcting a frequency offset of the first base station and correcting time offset by measuring the time difference as the sum of a clock error and a propagation delay from the second base station to the first base station.

5. The method of claim 1, wherein the obtaining step includes the substeps of:
requesting a user device attached to the first base station to measure a synchronization parameter of the second base station, and
receiving a report from the user device reporting the measured synchronization parameter.

6. The method of claim 5, further comprising the substeps of:
synchronizing the user device with the second base station; and
measuring the synchronization parameter by the user device.

7. The method of claim 5, further comprising the substeps of:
synchronizing the user device with the second base station; and
computing a frame alignment time offset and a frequency offset between the first base station and the second base station by the user device; and
wherein the receiving substep reports the computed offsets as synchronization parameters to the first base station.

8. The method of claim 1, further comprising the step of disabling user device downlink reception and uplink transmission during the obtaining step.

9. The method of claim 1, wherein the first base station and second base station operate in the same frequency band.

10. The method of claim 1, wherein the first base station and second base station operate in different frequency bands.

11. A method for timing synchronization in a first base station of a first communication network via an overlaying second base station of second communication network uncoordinated with the first communication network, the method comprising the step of:
obtaining timing synchronization information by identifying a strongest broadcast synchronization signal preamble from nearby second base stations; and
adjusting a clock of the first base station in response to the synchronization information by correcting a frequency offset of the first base station and measuring the time difference as the sum of a clock error and a propagation delay from the second base station to the first base station.

12. The method of claim 11, wherein the obtaining step includes the substeps of:
requesting a user device attached to the first base station to obtain the synchronization information,
synchronizing the user device with the second base station,
measuring at least one synchronization parameter by the user device, and
sending a report from the user device reporting the measured at least one synchronization parameter.

13. The method of claim 12, wherein the measuring substep includes computing a frame alignment time offset and a frequency offset between the first base station and the second base station by the user device as the at least one synchronization parameter.

14. The method of claim 11, further comprising the step of disabling user device downlink reception and uplink transmission during the obtaining step.

15. The method of claim 11, wherein the obtaining step includes identifying a common user device absence time period while obtaining timing synchronization information from the second base station.

16. The method of claim 11, wherein the obtaining step includes sending a RRC_Connection_Reconfiguration message to users to configure their DRX parameters to ensure that there exists a common time interval that is long enough to be used by the first base station to obtain timing synchornization information from the second base station.

17. The method of claim 11, wherein the obtaining step occurs when a user device is operating in a gap period of a compressed mode.

18. The method of claim 11, wherein during the obtaining step the first base station schedules no transmissions.

19. The method of claim 11, wherein the obtaining step includes creating a measurement gap with an empty cell list for the UEs.

20. The method of claim 11, wherein the obtaining step includes a network element reporting UE paging occasions to their home BS.

21. The method of claim 11, wherein the obtaining step includes network allocating the same paging occasion for all UEs camping on a femto-cell.

22. The method of claim 11, wherein the obtaining step includes the home BS keeping UEs in connected mode by not sending a RRC_Connection_Release message.

23. The method of claim 11, wherein the home BS sends a message to notify its UEs that it will not be available for a certain amount of time.

24. The method of claim 11, further comprising the steps of:
broadcasting an identification of the second base station that the first base-station synchronizes to by the first base station; and
periodically comparing the value of the identification to second base station identifications broadcasted by neighboring base stations of the first communication network, wherein if a neighboring base station broadcasts a different second base station identification, the first base station will re-synchronize to this second base station with the different second base station identification.

25. A first base station of a first communication network, the first base station operable to provide itself timing synchronization via a second base station of second communication network uncoordinated with the first communication network, the first base station comprising:
a clock operable to maintain timing of the first base station;
a receiver operable to obtain timing synchronization information from the second base station; and
a processor coupled to the clock and the receiver, the processor operable to adjust the clock in response to the synchronization information.
